(19) United States
(12) Patent Application Publication
(10) Pub. No.: US 2011/0247159 A1
(43) Pub. Date: Oct. 13, 2011

(54) DENTAL CLEANING MOUTHPIECE WITH REPLACEABLE BRISTLE FIELDS

(75) Inventors: Jelte Steur, Delft (NL); Evert Alle Helfrich, Bellevue, WA (US); Martinus Bernardus Stapelbroek, Frieschepalen (NL); Arif Veendijk, Assen (NL)

(73) Assignee: KONINKLIJKE PHILIPS ELECTRONICS N.V., EINDHOVEN (NL)

(21) Appl. No.: 13/139,358

(22) PCT Filed: Dec. 4, 2009
(86) PCT No.: PCT/IB2009/055517

§ 371 Date: Jun. 13, 2011

Related U.S. Application Data
(60) Provisional application No. 61/141,064, filed on Dec. 29, 2008.

(51) Int. Cl. A61C 17/22

(52) U.S. Cl. 15/167.1

(57) ABSTRACT

The dental mouthpiece includes an assembly (14, 16, 18) for holding a bristle field or fields (20) used to clean teeth when the mouthpiece is actuated, and a power assembly (12) for moving the bristle-holding structure and the bristle fields so that the bristles produce a cleaning action on the teeth, wherein the bristle fields are replaceable.

This invention relates generally to dental mouthpieces for cleaning teeth, and more specifically concerns a structural arrangement for replacing the bristle field in such mouthpieces.

It is well known that conventional toothbrushes should be replaced at regular intervals because the individual bristles wear and the entire bristle field splays. Further, the bristles often become a convenient place for bacteria and viruses after extended use. The American Dental Association recommends that conventional toothbrushes be replaced every three months or so. With electric toothbrushes, only the removable bristle brushheads are replaced, as opposed to the entire appliance. A replaceable brushhead in a power toothbrush has the additional advantage of allowing a user to choose between several different brushheads, but using the same handle, to accomplish different cleaning functions or special purposes. For instance, some brushheads may have bristles specifically adapted for polishing the teeth, while others may have bristles particularly arranged for cleaning the flat surfaces of teeth, and still others for cleaning interproximal spaces of the teeth.

In a dental cleaning mouthpiece that includes bristles for removing/reducing plaque, there is the same need for replacing the bristle field at regular intervals. However, since a dental cleaning mouthpiece is so different from a toothbrush, the replacement of the bristle field in a mouthpiece presents different challenges than those encountered in a power toothbrush, for instance.

Accordingly, it is desirable to have one or more arrangements for a replaceable bristle field capability for dental cleaning mouthpieces.

Accordingly, a dental mouthpiece for cleaning teeth comprises: a structure for holding a field or fields of bristles used to clean teeth when the mouthpiece is actuated; and a power assembly for moving the bristle field holding structure such that the bristles produce a cleaning action on the teeth, wherein the bristle fields are replaceable.

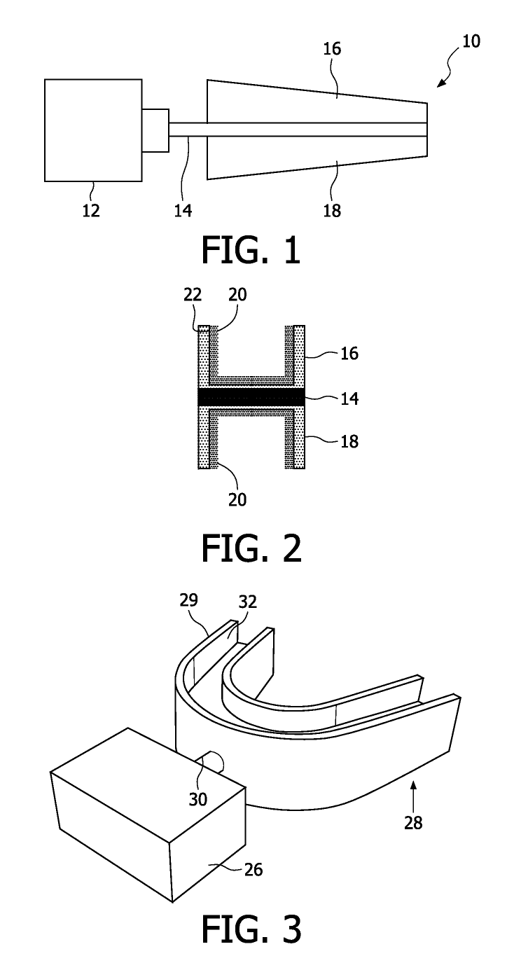

FIG. 1 is a side view of one embodiment of the present invention.

FIG. 2 is a cross-sectional diagram of the embodiment of FIG. 1.

FIG. 3 is a perspective view of another embodiment of the present invention.

FIG. 4 is a cross-sectional view of a portion of the embodiment of FIG. 3.

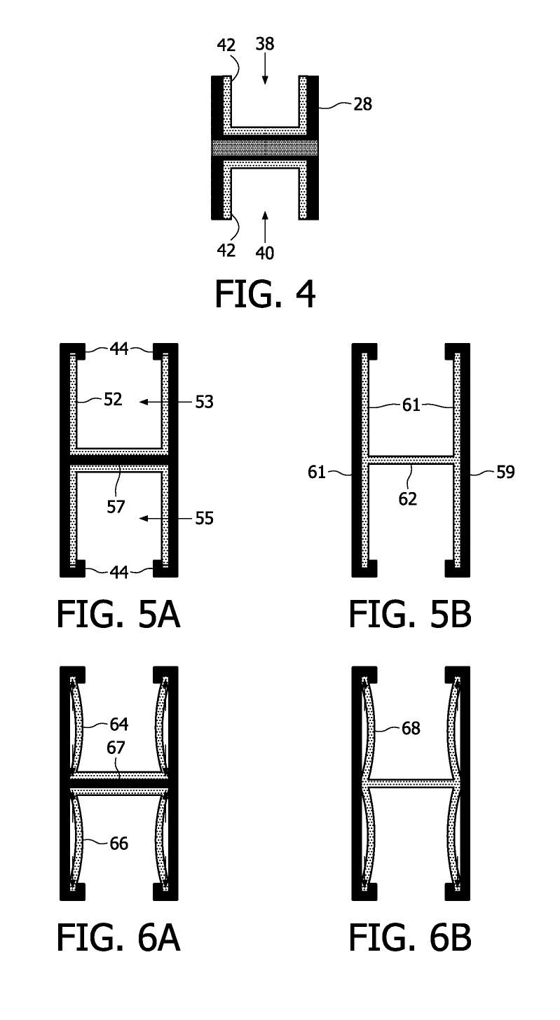

FIGS. 5A and 5B are cross-sectional diagrams of a portion of a variation of the embodiment of FIG. 3.

FIGS. 6A and 6B are cross-sectional diagrams showing a portion of another variation of the arrangements of FIG. 3.

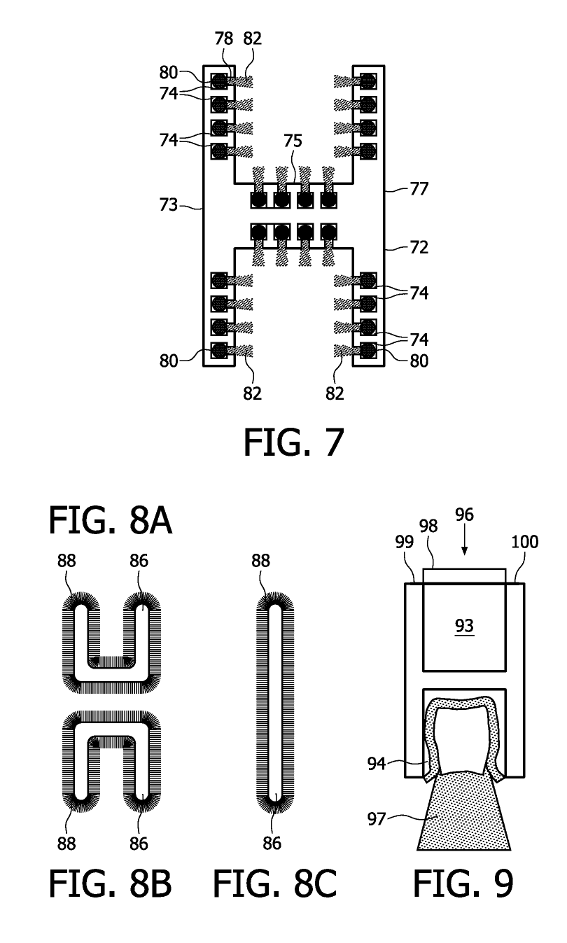

FIG. 7 is a cross-sectional diagram showing a portion of another embodiment of the present invention.

FIGS. 8A-8C are cross-sectional diagrams showing a further embodiment of the present invention.

FIG. 9 is a cross-sectional diagram showing another embodiment of the present invention.

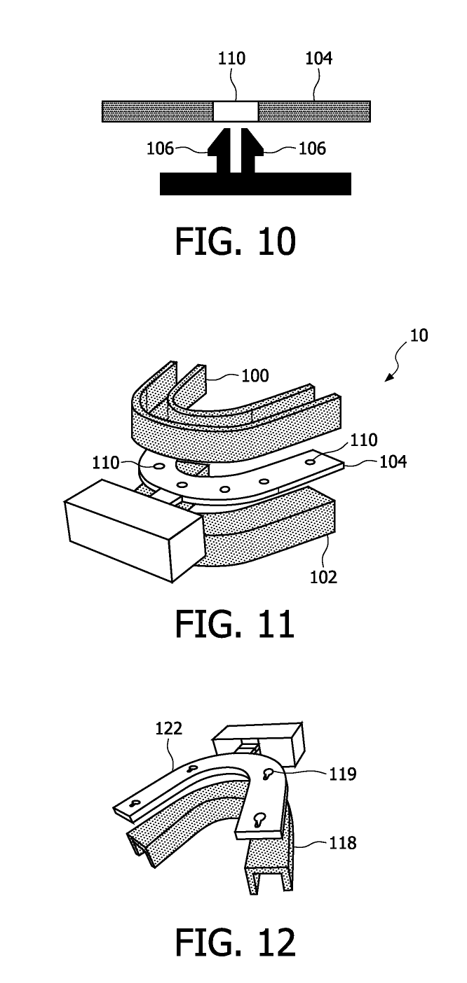

FIGS. 10 and 11 are, respectively, cross-sectional diagram and an exploded view of one arrangement for connecting teeth-receiving carrier portions of a mouthpiece to a driver element for the mouthpiece.

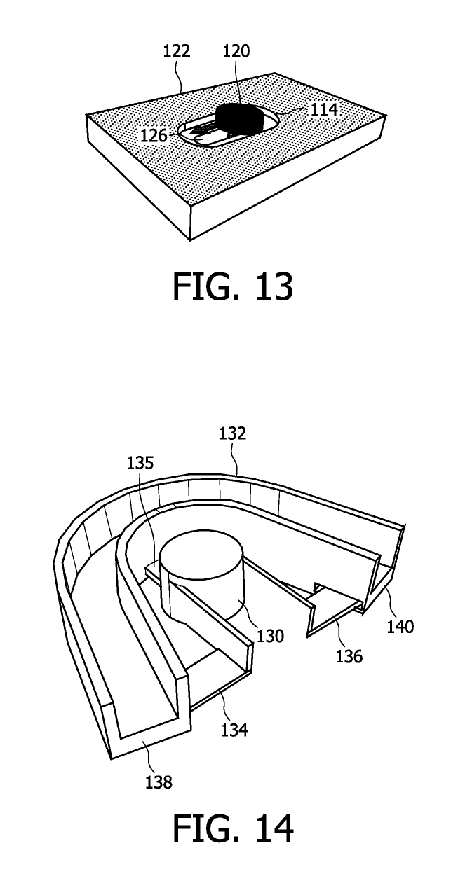

FIGS. 12 and 13 are exploded and perspective views showing another arrangement for connecting teeth-receiving carrier portions to a driver element.

FIG. 14 is a perspective view showing another arrangement for connecting the teeth-receiving carrier portions to a driver element.

FIGS. 1, 2, 10 and 11 show one teeth cleaning mouthpiece arrangement generally at 10, which includes in FIGS. 1 and 2 a driver and control unit 12, and a rigid drive plate 14 extending therefrom in the general shape of a horseshoe. The mouthpiece includes upper and lower rigid horseshoe-shaped teeth-receiving carrier members 16 and 18, configured to receive the upper and lower teeth of a user.

In operation, drive plate 14 is moved by the drive unit, with the drive plate in turn driving/moving the carrier members which each carry a bristle field or fields 20 on the inner surfaces thereof. Movement of the carrier members result in a cleaning action on the teeth produced by the bristles. Various kinds of movement are possible to produce various cleaning actions, including scrubbing, tapping and other carrier motions. The bristle fields 20 are positioned on a thin, flexible support member 22 which is attachable to the rigid carriers 16 and 18 by adhesives or the like. The bristle fields are on the interior vertical side surfaces and the two intermediate horizontal surfaces of the carrier members. In this embodiment, the rigid carriers with the bristle fields can be replaced as entire units, or the bristle support member with the bristle fields can be replaced separately from the carriers.

FIGS. 10 and 11 show one embodiment for connecting individual rigid carrier members 100 and 102 to a driving plate 104, as shown generally in FIGS. 1 and 2. This connection can be made by means of a snap connection (FIGS. 10 and 11), in which protrusions 106 on the carrier members are snapped into corresponding openings 110 in the driving plate. When the carrier members (with the bristle fields) are to be removed to replace the bristles, the protrusions 106 are squeezed together and the carrier members separated from the driving plate 104. FIGS. 12 and 13 show a similar structure, except that the connection comprises a mushroom-shaped pin 120 on the carrier members 118 which pin is then fitted into an opening 119 in driving plate 122 and then moved slightly along a narrow channel 126 to a position where the carrier member 118 is locked to the driving plate 122. The carrier members can be removed by moving the carrier member in an opposing direction to where the mushroom-shaped pin is positioned in opening 119 of the driving plate.

In another embodiment, shown in FIG. 3, the driver/control system 26 is connected directly to a single unit mouthpiece member 28 having an upper portion 29 and a lower portion (only the upper portion is clearly visible in FIG. 3) which receive the upper and lower teeth of a user. This is referred to as an integrated system. The driver/controller 26 moves the mouthpiece member 28 directly through a connecting element 30. Positioned on the interior (teeth facing) surfaces of both the upper and lower portions of the mouthpiece member are bristle fields 32, which are mounted on thin, flexible support members which are in turn removably connected to the mouthpiece 28 itself, conforming to the surface configuration thereof when applied thereto. The mouthpiece member 28 in FIG. 3 is typically not removable/replaceable from the driver/control 26, although in a variation, it can be. The connection between the bristle support members and the mouthpiece member 28 can be by means of an adhesive or by other means, such as welding, molding and suction cup elements, for instance. This arrangement is shown more clearly in FIG. 4, for instance, which is a cross-section of one side of mouthpiece member 28, showing both upper and lower portions 38 and 40. The flexible support members with bristle fields are shown at 42.

FIGS. 5A and 5B show another bristle field embodiment for the integrated driver/mouthpiece arrangement of FIG. 3. In this case, however, the mouthpiece element is configured to have small U-shaped portions 44 along the upper and lower edges of the mouthpiece element. Flexible support members 52 with bristle fields thereon define U-shaped structures which are slid into the upper and lower portions of the mouthpiece.

FIG. 5A divides the upper and lower portions 53, 55 with an intermediate member 57. FIG. 5B shows a similar mouthpiece structure but without a continuous intermediate member. The two side members 58 and 59 of the mouthpiece in FIG. 5B are connected by narrow intermediate members (not shown) at the two free ends of the mouthpiece and at the middle of the mouthpiece, which coincides with the position of the two front teeth. The flexible member with bristle fields in this embodiment is in the form of an “H”, with side portions 61 and a center portion 62. With the three connection elements, one portion of the flexible member extends from one end of the mouthpiece to approximately the middle thereof, while another extends from middle to the other end. Additional connections between the side member of the mouthpiece are of course possible, with the length of the H-shaped flexible support member portions changing accordingly.

FIGS. 6A and 6B show a similar structure, except that the flexible support members are more rigid and snap into place within the mouthpiece structure, either with separate members (each U-shaped) 64 and 66 snapping into place within the upper and lower portions, respectively or a single H-shaped member. In FIG. 6A, the upper and lower portions are connected with an intermediate element 67 along the entire mouthpiece. FIG. 6B is similar to the FIG. 5B, with side members connected at a few points by an intermediate element and an H-shaped support member 68 with bristle fields which is configured to snap into the mouthpiece member.

FIG. 7 shows another embodiment for the integrated drive/mouthpiece arrangement shown in FIG. 3. FIG. 7 is a cross-section of one side of the mouthpiece. In this case, mouthpiece unit 72 includes a plurality of longitudinal channels 74 in the interior surfaces of side members 73 and 77 and in the upper and lower surfaces of intermediate member 75. Positioned within the channels are bristle rows 78 which are typically replaced row by row. Each row of bristles contains a base portion 80 which fits within the channels 74, which are configured to hold the base portion. Extending from base portion 80 are individual bristles 82.

FIGS. 8A-8C show a thin bristle support or base member 86 with bristles 88 extending therefrom along both sides of the length thereof. Base member 86 is made from a putty/gel-like material which is very flexible and can be molded into the shape of the carrier members, taking on a U-shaped form, such as shown in FIGS. 8A and 8B. As the bristles wear, the bristle base member with bristles can be removed and turned inside-out, providing a second life before having to be replaced.

FIG. 9 shows still another embodiment for an integrated driver/mouthpiece arrangement with upper and lower mouthpiece sections 93 and 94. In this embodiment, a membrane 96 with bristles 98 extending therefrom is placed across each of the upper and lower openings of the “H” shaped mouthpiece, connecting the free edges 99 and 100 thereof. When the mouthpiece is inserted into the mouth, and teeth 97 are pushed into the upper and lower sections of the mouthpiece, the membrane conforms to the shape of the teeth, as shown in lower section 94. The edges of the membrane 96 are clamped to the free edges of the upper and lower mouthpiece sections.

FIG. 14 shows another embodiment involving a central driver/control member 130 which is separable from a horseshoe-shaped mouthpiece element 132. The driver control member is connected to the mouthpiece element by three connecting beams 134-136. Beam 135 is first inserted into the mouthpiece element 132. The free ends 138, 140 of the mouthpiece element are then bent outwardly about a hinge portion or portions to permit insertion of opposing beams 134 and 136 into the mouthpiece element. When the mouthpiece is allowed to rebound to its original shape, the beams connect to the mouthpiece elements. The mouthpiece is then fixed to the beams. Although a mouthpiece covering only one-half of the mouth is specifically shown, mouthpiece 132 could be configured to have both upper and lower sections, to receive both upper and lower teeth.

Accordingly, several embodiments have been disclosed for replacing a bristle field in a mouthpiece used for cleaning teeth.

Although a preferred embodiment of the invention has been disclosed for purposes of illustration, it should be understood that various changes, modifications and substitutions may be incorporated in the embodiment without departing from the spirit of the invention which is defined by the claims which follow.

1. A dental mouthpiece for cleaning teeth comprising:
a structure (14, 16, 18) for holding a field or fields of bristles used to clean teeth when the mouthpiece is actuated; and
a power assembly (12) for moving the bristle field holding structure such that the bristles produce a cleaning action on the teeth, wherein the bristle fields are replaceable.

2. The dental mouthpiece of claim 1, wherein the bristle fields vary in configuration, in accordance with the configuration of the holding structure.

3. The dental mouthpiece of claim 1, wherein the structure for holding the field or fields of bristles includes a rigid carrier (100, 102) and wherein the bristle fields comprise bristles mounted on a thin, flexible support element (22) which is attachable to and removable from the rigid carrier.

4. The dental mouthpiece of claim 1, wherein the bristle field holding structure with the set of bristle fields is replaceable from the power assembly.

5. The dental mouthpiece of claim 4, wherein the power assembly includes a drive element (14, 104) which is connected to and provides support for the bristle field holding structure, and wherein the bristle field holding structure with the bristle fields is removable from the drive element.

6. The dental mouthpiece of claim 5, wherein said holding structure includes upper and lower sections (38, 40) configured to receive the upper and lower teeth of a user, and wherein the support member fits within and is replaceable from the upper and lower sections of the holding structure.

7. The dental mouthpiece of claim 6, wherein said holding structure is a single unit, and wherein the support member is a single unit covering both the upper and lower teeth.

8. The dental mouthpiece of claim 1, wherein the holding structure is integrated with the power assembly and wherein the holding structure includes channels (74) into which rows of bristle tufts (78) are insertable and are removable from for cleaning of teeth.

9. The dental mouthpiece of claim 3, wherein the support member is a putty material from which bristle tufts extend, the putty material being moldable into the shape of the mouthpiece.

10. The dental mouthpiece of claim 6, wherein the support member is a membrane (98) which is positioned initially across free edges (99, 100) of the mouthpiece sections portions, and which is arranged so that it is pushed into the mouthpiece sections and conforms to the shape thereof by action of the teeth biting into the mouthpiece sections when the mouthpiece is positioned in the mouth of the user.

11. The dental mouthpiece of claim 4, wherein the mouthpiece portions are connected to the driver plate by snap connections (106).

12. The dental mouthpiece of claim 4, wherein the mouthpiece portions are connected to the driver plate by a button connection (120) which is mateable with a corresponding opening (119) in the driver plate.

13. The dental mouthpiece of claim 3, wherein the power assembly is connected to the mouthpiece member by at least three separate beam elements 134-136).
